(19) United States
(12) Patent Application Publication
(10) Pub. No.: US 2010/0048392 A1
(43) Pub. Date: Feb. 25, 2010

(54) CATALYST FOR PURIFYING EXHAUST GASES AND PROCESS FOR PRODUCING THE SAME

(75) Inventors: Seiji Okawara, Aichi-ken (JP); Takayuki Endo, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: TOYOTA JIDOSHA KABUSHIKI KAISHA, Toyota-shi, Aichi-ken (JP); CATALER CORPORATION, Shizuoka (JP)

(21) Appl. No.: 11/922,216

(22) PCT Filed: Jun. 20, 2006
(86) PCT No.: PCT/JP2006/312683

§ 371 Date: Nov. 13, 2009

(30) Foreign Application Priority Data
Jun. 20, 2005 (JP) 2005-179501

(51) Int. Cl. B01J 23/58; B01J 23/02; B01J 23/04

(52) U.S. Cl. 502/328; 502/330; 502/340; 502/344

(57) ABSTRACT

A catalyst for purifying exhaust gases includes a substrate, and projections. The substrate is provided with straight-flow gas-flow passages. The projections protrude from the straight-flow gas-flow passages in a height of 50 μm or more, and include a precipitate, which is composed of at least one catalytic ingredient selected from the group consisting of alkali metals and alkaline-earth metals.

### TECHNICAL FIELD

The present invention relates to a catalyst for purifying exhaust gases, catalyst which can purify particulate matters (hereinafter abbreviated to as “PMs”), included in exhaust gases such as those emitted from diesel engines, efficiently by means of oxidation, and a process for producing the same. In particular, it relates to a straight-flow catalyst for purifying exhaust gases, straight-flow catalyst which is provided with a plurality of gas passages whose opposite ends are opened, and a process for producing the same.

### BACKGROUND ART

Regarding gasoline engines, harmful components in the exhaust gases have been reduced securely by the strict regulations on the exhaust gases and the technological developments capable of coping with the strict regulations. However, regarding diesel engines, the regulations and the technological developments have been advanced less compared to those of gasoline engines because of the unique circumstances that the harmful components are emitted as PMs.

As exhaust-gas purifying apparatuses having been developed so far for diesel engines, the following have been known. For example, the exhaust-gas purifying apparatuses can be roughly divided into trapping (or wall-flow) exhaust-gas purifying apparatuses and open (or straight-flow) exhaust-gas purifying apparatuses. Among these, plugged honeycomb structures made from ceramic (i.e., diesel PMs filters, hereinafter referred to as “DPFs”) have been known as one of the trapping exhaust-gas purifying apparatuses. As set forth in the SAE paper, SAE810114, for instance, the plugged ceramic honeycomb structures of DPFs are provided with a plurality of cells. Specifically, the cells comprise inlet cells, which are plugged on the exhaust-gas downstream opposite end, outlet cells, which neighbor the inlet cells and are plugged on the exhaust-gas upstream opposite end, and filter cellular walls, which demarcate the inlet cells and the outlet cells. Thus, the DPFs are a wall-flow exhaust-gas purifying apparatus which filters exhaust gases with the pores of the cellular walls and capture PMs onto the cellular walls so that PMs are inhibited from being emitted.

On the other hand, an open exhaust-gas purifying apparatus comprises a straight-flow honeycomb structure, which is provided with a plurality of cells whose both ends are opened, similarly to catalysts for purifying exhaust gases emitted from gasoline engines. The open exhaust-gas purifying apparatus purifies PMs, which contact with a catalytic layer coated on the cells' cellular walls.

In the DPFs, however, the pressure loss increases as PMs deposit thereon. Accordingly, it is needed to regularly remove deposited PMs to recover the DPFs by certain means. Hence, when the pressure loss increases, deposited PMs have been burned conventionally by heating the DPFs with burners or electric heaters or by supplying high-temperature exhaust gases to the DPFs, thereby recovering the DPFs. However, in this case, the greater the deposition of PMs is, the higher the temperature increases in burning deposited PMs. Consequently, there might arise cases that the DPFs are damaged by thermal stress resulting from such burning.

Hence, continuously regenerative DPFs have been developed recently. In the continuously regenerative DPFs, a coating layer comprising alumina is formed on the cellular walls of the DPFs, and a catalytic ingredient, such as a platinum-group noble metal, is loaded on the coating layer. In accordance with the continuously regenerative DPFs, since the captured PMs are burned by oxidation by means of the catalytic activity of the catalytic ingredient, it is possible to regenerate the DPFs by burning PMs simultaneously with or successively after capturing PMs. Moreover, since the catalytic reaction of the catalytic ingredient occurs at relatively low temperatures, and since PMs can be burned when they are captured less, the continuously regenerative DPFs produce an advantage that the thermal stress acting onto the DPFs is so less that the DPFs are inhibited from being damaged.

On the contrary, straight-flow catalysts for purifying PMs exhibit less pressure loss, but might suffer from a problem that PMs, which are not purified but are emitted as they are, are emitted in a larger amount. On the other hand, since wall-flow catalysts for purifying PMs are structured so that PMs are filtered when exhaust gases pass through the cellular walls, they might have a disadvantage that they exhibit larger pressure loss than straight-flow PMs-purifying catalysts do.

Moreover, Japanese Unexamined Patent Publication (KOKAI) No. 2002-35,583 discloses an exhaust-gas purifying system, which comprises a DPF, and a burning catalytic apparatus disposed on an upstream side with respect to the DPF. The burning catalytic apparatus is provided with a surface, which is shaped irregularly to enlarge the specific surface area and in which a noble metal is loaded on the irregularly-shaped portion. The thus constructed exhaust-gas purifying system can purify gaseous components, such as unburned fuels and hydrocarbons (hereinafter abbreviated to as “HC”), with the upstream-side burning catalytic apparatus, and can capture PMs with the downstream-side DPF.

However, even in the exhaust-gas purifying system disclosed in Japanese Unexamined Patent Publication (KOKAI) No. 2002-35, 583, the irregularly-shaped portion of the upstream-side burning catalytic apparatus only exhibits a roughness of not smaller than 1 μm approximately. Accordingly, it is difficult for the upstream-side burning catalytic apparatus to capture and purify PMs completely. Consequently, it is essential to dispose a DPF on a downstream side with respect to the burning catalytic apparatus. Since the exhaust-gas purifying system requires the downstream-side DPF as an essential element, it cannot solve the problem associated with DPFs that the pressure loss is larger.

Hence, Japanese Unexamined Patent Publication (KOKAI) No. 2003-326,162 proposes a catalyst for purifying exhaust gases, catalyst which comprises a straight-flow substrate, a catalytic layer, heat-resistant particles and a noble metal. The catalytic layer is formed on part of the cellular walls of the straight-flow substrate at least. The heat-resistant particles are fastened onto the catalytic layer, and comprise coarse particles whose particle diameters are larger than the thickness of the catalytic layer. The noble metal is involved in the catalytic layer. In accordance with the exhaust-gas purifying catalyst, PMs, which flow in the cells of the straight-flow substrate, collide with the coarse particles so that they are inhibited from flowing. Thus, PMs stagnate so that they are put in a temporarily captured state. Note that the stagnating PMs are likely to contact with the catalytic layer with higher probability so that they are likely to be purified by the noble metal by means of oxidation. Accordingly, the exhaust-gas purifying catalyst demonstrates high PMs-purifying performance. Moreover, the exhaust-gas purifying catalyst is a straight-flow type exhaust-gas purifying apparatus basically, though the coarse particles protrude from the cellular walls within the cells of the straight-flow substrate. Consequently, the exhaust-gas purifying catalyst exhibits less pressure loss than DPFs do.

However, the exhaust-gas purifying catalyst disclosed in Japanese Unexamined Patent Publication (KOKAI) No. 2003-326,162 is structured so that the coarse particles are simply fastened onto the catalytic layer. Accordingly, there might occur cases that the coarse particles have come off from the catalytic layer when the exhaust-gas purifying catalyst is put in service. If such is the case, it is difficult for the exhaust-gas purifying catalyst to capture PMs. Consequently, there might arise a problem that the exhaust-gas purifying catalyst shows degraded PMs-purifying performance. Moreover, since the heat-resistant particles do not at all have any catalytic function, the exhaust-gas purifying catalyst requires the catalytic layer, which involves a noble metal, as an essential element.

### DISCLOSURE OF THE INVENTION

The present invention has been developed in view of the aforementioned circumstances. It is therefore an object of the present invention not only to provide gas-flow passages with projections, which are free from a drawback, such as the coming-off, and exhibit a long longevity, but also to give such projections per se a catalytic function.

A catalyst for purifying exhaust gases according to the present invention can achieve the aforementioned object. The present catalyst is for purifying exhaust gases, and comprises:

a substrate provided with straight-flow gas-flow passages; and

projections protruding from the straight-flow gas-flow passages in a height of 50 μm or more, and comprising a precipitate composed of at least one catalytic ingredient selected from the group consisting of alkali metals and alkaline-earth metals.

In the present catalyst, the straight-flow gas-flow passages can preferably be provided with a pore opening whose diameter is 10 μm or more; and the projections can preferably be held onto the straight-flow gas-flow passages by means of anchor effect. Note that it is advisable to construct the present catalyst so as to further comprise a catalytic layer formed on the straight-flow gas-flow passages and comprising a noble metal, wherein: the projections protrude from the catalytic layer. Moreover, the present catalyst can preferably further comprise an oxidizing catalyst disposed on an exhaust-gas flow upstream side with respect to the catalyst.

A process according to the present invention for producing a catalyst for purifying exhaust gases comprises the steps of:

loading at least one catalytic ingredient, selected from the group consisting of alkali metals and alkaline-earth metals, on a substrate, provided with straight-flow gas-flow passages, in an amount of 0.3 mol or more with respect to 1-L volume of the substrate;

heat-treating the substrate with the catalytic ingredient loaded, thereby precipitating a precipitate, composed of the catalytic ingredient, so as to provide the straight-flow gas-flow passages with projections, protruding from the straight-flow gas-flow passages in a height of 50 μm or more.

In the present production process, it is advisable that the straight-flow gas-flow passages of the substrate can be provide with a catalytic layer, which comprises a noble metal and which is formed in advance.

Thus, the present catalyst comprises the projections, which protrude from the straight-flow gas-flow passages in a height of 50 μm or more. Accordingly, PMs, which flow in the straight-flow gas-flow passages, collide with the projections, and are thereby inhibited from flowing. Consequently, it is believed that PMs stagnate within the straight-flow gas-flow passages so that they are put in a temporarily captured state. Moreover, the projections comprise a precipitate, which is composed of at least one catalytic ingredient selected from the group consisting of alkali metals and alkaline-earth metals. Note that the catalytic ingredient has an oxidizing activity intrinsically, which enables it to oxide soot components, which are contained in PMs, at least. Therefore, the temporarily captured PMs contact with the catalytic ingredient with enhanced probabilities, and are thereby purified by the catalytic ingredient by means of oxidation. In addition, even when the projections protrude into the straight-flow gas-flow passages, the present catalyst exhibits less pressure loss than DPFs do, because the substrate of the present catalyst is a straight-flow substrate fundamentally.

Specifically, the present catalyst can demonstrate good performance in both of PMs-purifying ability and pressure-loss reduction compatibly.

Moreover, the present production process makes it possible to produce the present catalyst, which comprises the projections, one of the characteristics of the present invention, readily and stably.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a microscope photograph for showing a particulate structure in a radial cross-section of a catalyst according to an example of the present invention.

FIG. 2 is a microscope photograph for showing a particulate structure in an axial cross-section of a catalyst according to an example of the present invention.

### BEST MODE FOR CARRYING OUT THE INVENTION

Having generally described the present invention, a further understanding can be obtained by reference to the specific preferred embodiments which are provided herein for the purpose of illustration only and not intended to limit the scope of the appended claims.

The present catalyst for purifying exhaust gases comprises a substrate, and projections. The substrate is provided with straight-flow gas-flow passages. The projections protrude from the straight-flow gas-flow passages of the substrate. The substrate can comprise at least one member selected from the group consisting of honeycomb-shaped substrates, foamed substrates and nonwoven substrates, which are provided with a plurality of cellular passages, respectively. The substrate can be made of materials, such as ceramic and metal, which exhibit heat resistance. The ceramic can be composed of cordierite, for instance.

Specifically, it is preferable to use a porous substrate, which is formed of ceramic or metallic nonwoven cloth, for making the substrate. The porous substrate can preferably exhibit an average pore diameter of from 10 to 50 μm and a porosity of from 10 to 80% by volume. Moreover, the porous substrate can further preferably exhibit an average pore diameter of from 10 to 40 μm and a porosity of from 40 to 80% by volume. Such a porous substrate is provided with pore openings whose diameters are 10 μm or more in the surfaces of the straight-flow gas-flow passages. In water-absorption loading methods, which have been utilized usually, catalytic ingredients are loaded preferentially on the pores by means of capillary phenomenon. Accordingly, the projections grow starting at the openings of the pores in the later-described heat-treating step of the present production process. Consequently, it is possible to firmly hold the resulting projections onto the straight-flow gas-flow passages by means of anchor effect. Therefore, it is possible to inhibit the projections from coming off from the straight-flow gas-flow passages when the present exhaust-gas purifying catalyst is put in service.

The projections protrude from the straight-flow gas-flow passages in a height of 50 μm or more. When the height of the projections is less than 50 μm, the resultant projections hardly produce the function of capturing PMs temporarily. On the other hand, when the height of the projections is more than 300 μm, the resultant projections occupy such an overgrown volume within the straight-flow gas-flow passages that they have clogged the straight-flow gas-flow passages to adversely enlarge the pressure loss of the resulting catalysts. Therefore, the height of the projections can preferably be 300 μm or less. Note that the projections can further preferably protrude from the straight-flow gas-flow passages in a height of from 100 to 250 μm, furthermore preferably from 150 to 250 μm.

It is advisable to arrange the present exhaust-gas purifying catalyst so that a catalytic layer can be formed on the straight-flow gas-flow passages and the projections can protrude from the catalytic layer. For example, the catalytic layer can preferably comprise a porous oxide, and a noble metal or a base metal loaded on the porous oxide. The porous oxide can preferably be composed of at least one member selected from the group consisting of alumina, zirconia, ceria and titania. The noble metal can preferably be composed of at least one member selected from the group consisting of Pt, Rh, Pd and Ir. The base metal can preferably be composed of at least one member selected from the group consisting of Co, Fe and Cu. The catalytic layer can be arranged in the same manner as the catalytic layers of conventional oxidizing catalysts and three-way catalysts.

The formation density of the projections is not limited in particular. However, when the projections are formed in a low density, it might be difficult for the projections to demonstrate the action of capturing PMs temporarily. Accordingly, it is preferable to form the projections in a high density, and it is further preferable to form the projections finely and in a high density. Moreover, the projections can be formed at various positions selectively depending on the forming purposes. However, it is especially preferable to form the projections uniformly over the entire straight-flow gas-flow passages. For example, the projections can preferably be formed in a formation density of from 2 to 20 pieces/mm², further preferably from 5 to 15 pieces/mm².

The projections comprise a precipitate, which is composed of at least one catalytic ingredient selected from the group consisting of alkali metals and alkaline-earth metals. From the viewpoint of the readiness of projection formation and the magnitude of PMs-oxidizing activity, the projections can preferably comprise a precipitate, which is composed of an alkali metal, especially preferably, potassium (K); or alternatively the projections can preferably comprise a precipitate, which is composed of an alkaline-earth metal, especially preferably, barium (Ba). In order to form the projections, the catalytic ingredient is loaded on the substrate in an amount of 0.3 mol or more with respect to 1-L volume of the substrate, and then the substrate with the catalytic ingredient loaded is heat-treated. When the loading amount of the catalytic ingredient is less than 0.3 mol with respect to 1-L volume of the substrate, the projections grow insufficiently so that it is difficult to form the projections whose height is 50 μm or more. It is especially preferable to load the catalytic ingredient on the substrate in an amount of 0.5 mol or more with respect to 1-L volume of the substrate. On the other hand, when the loading amount of the catalytic ingredient is too much, the projections have grown to a height of more than 300 μm. Therefore, it is preferable to load the catalytic ingredient on the substrate in an amount of 5 mol or less with respect to 1-L volume of the substrate, and it is further preferable to load the catalytic ingredient on the substrate in an amount of 1 mol or less with respect to 1-L volume of the substrate. Note that the loading amount of the catalytic ingredient can furthermore preferably fall in a range of from 0.5 to 2 mol, moreover preferably from 0.5 to 1 mol, with respect to 1-L volume of the substrate.

Moreover, when the present exhaust-gas purifying catalyst is further provided with the catalytic layer, it is preferable to load the catalytic ingredient, which comprises at least one member selected from the group consisting of alkali metals and alkaline-earth metals, in an amount of 4 mol or more with respect to 1-kg weight of the catalytic layer. When the loading amount of the catalytic ingredient is less than 4 mol with respect to 1-kg weight of the catalytic layer, the projections are less likely to grow so that it is difficult to form the projections whose height is 50 μm or more. Note that the catalytic ingredient can be loaded on the catalytic layer after forming the catalytic layer, or can be loaded in the catalytic layer simultaneously with the formation of the catalytic layer. Moreover, the catalytic ingredient can preferably be loaded in an amount of from 4 mol or more to 50 mol or less, further preferably from 6 mol or more to 15 mol or less, with respect to 1-kg weight of the catalytic layer.

The step of heat-treating the substrate with the catalytic ingredient loaded, which follows the step of loading the catalytic ingredient, can be carried out in air. In this instance, the substrate with the catalytic ingredient loaded can preferably be heat-treated at a temperature falling in a range of from 200 to 600° C., further preferably from 300 to 500° C. When the heat-treatment temperature is lower than 200° C., the growth rate of the projections is so slow that it has taken a long period of time to form the projections whose height is 50 μm or more. On the other hand, when the heat-treatment temperature is higher than 600° C., there might arise the case where no projection is formed because the catalytic ingredient might react with the substrate or solve into the substrate.

Since the projections of the present exhaust-gas purifying catalyst comprise the catalytic ingredient, which comprises at least one member selected from the group consisting of alkali metals and alkaline-earth metals, only, the simple present exhaust-gas purifying catalyst might suffer from a drawback that NO₂ whose oxidizing activity is high is less likely to generate. Hence, the present exhaust-gas purifying catalyst can preferably be further provided with an oxidizing catalyst, which is disposed on an exhaust-gas flow upstream with respect to the simple present exhaust-gas purifying catalyst. When the present exhaust-gas purifying catalyst is thus constructed, NO₂, which the oxidizing catalyst generates, flows into the present simple exhaust-gas catalyst. Therefore, the oxidation of PMs, which the projections capture temporarily, is furthermore facilitated. In particular, in low-temperature regions of less than 300° C., the catalytic ingredient, which comprises at least one member selected from the group consisting of alkali metals and alkaline-earth metals, is less likely to demonstrate the PMs oxidizing activity. From this viewpoint as well, it is preferable to have NO₂, which the oxidizing catalyst generates, supplement the oxidation of PMs, which the catalytic ingredient effects. Note that the oxidizing catalyst can preferably comprise a straight-flow structure substrate, a coating layer formed on the straight-flow structure substrate, and an oxidizing catalytic ingredient loaded on the coating layer. The coating layer can preferably be composed of at least one member selected from the group consisting of alumina, titania and zeolite, and can preferably be formed in an amount from 10 to 200 g, furthermore preferably from 20 to 100 g, with respect to 1-L of the straight-flow structure substrate. The oxidizing catalytic ingredient can preferably be composed of at least one member selected from the group consisting of ruthenium (Ru), rhodium (Rh), palladium (Pd), osmium (Os), iridium (Ir) and platinum (Pt), and can preferably be loaded in an amount from 0.1 to 10 g, furthermore preferably from 0.5 to 5 g, with respect to 1-L of the straight-flow structure substrate.

### EXAMPLES

The present exhaust-gas purifying catalyst will be hereinafter described in more detail with reference to specific examples and comparative examples.

### Example No. 1

A honeycomb substrate was prepared. Note that the honeycomb substrate was made from cordierite, and had a volume of 2 L. Moreover, the honeycomb substrate comprised cells in a quantity of 300 cells/in², and exhibited an average pore diameter of 25 μm and a porosity of 65% by volume. In addition, the honeycomb substrate was for DPF applications, and comprised gas-permeable cellular walls. However, the honeycomb substrate was not provided with any plugs at all, and accordingly the honeycomb passages made a straight-flow structure honeycomb structure. The honeycomb substrate was immersed into an alumina sol, which exhibited a nm-order primary particle diameter. Then, the honeycomb substrate was taken up from the alumina sol, and was blown with air to blow off the excessive alumina sol. Thereafter, the honeycomb substrate was dried at 120° C., and was further calcined at 500° C. for 2 hours. Thus, an alumina coating layer was formed on and within the honeycomb substrate. Note that the alumina coating layer was formed in a small amount of 35 g with respect to 1-L volume of the honeycomb substrate, and was formed on the cellular walls as well as within the pores.

Subsequently, the honeycomb substrate provided with the alumina coating layer was impregnated with a predetermined amount of a platinum dinitrodiammine aqueous solution having a prescribed concentration. Then, the honeycomb substrate was dried at 120° C., and was further calcined at 500° C. for 1 hour. Thus, Pt was loaded uniformly on and within the aluminum coating layer in an amount of 2 g with respect to 1-L volume of the honeycomb substrate.

Moreover, the honeycomb substrate with Pt loaded on the alumina coating layer was impregnated with a predetermined amount of a potassium acetate aqueous solution having a prescribed concentration. Then, the honeycomb substrate was dried at 120° C., and was further calcined at 500° C. for 1 hour. Thus, K was loaded on and within the aluminum coating layer in an amount of 0.5 mol with respect to 1-L volume of the honeycomb substrate.

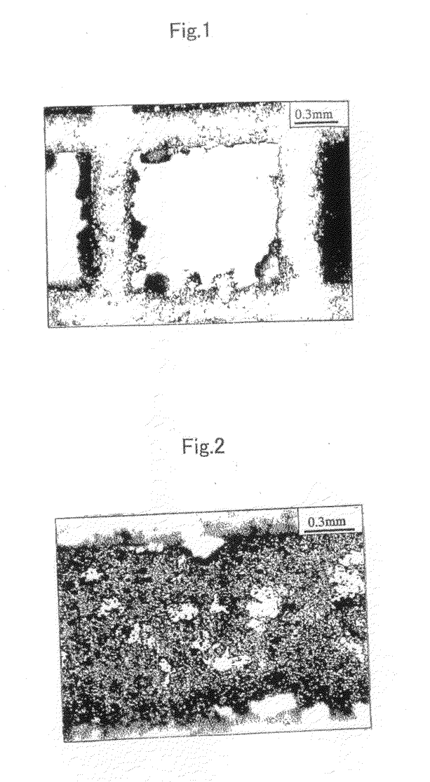

Finally, the resulting honeycomb substrate was heat-treated at 650° C. in air for 20 hours. Thus, a catalyst according to Example No. 1 of the present invention was produced. FIGS. 1 and 2 are microscope photographs, which show cross-sections of the catalyst according to Example No. 1. Specifically, FIG. 1 is a microscope photograph, which shows a radially-cut cross-section of the catalyst according to Example No. 1, and in which the cross-sections of the cellular walls and the cellular passages are observed. Moreover, FIG. 2 is a microscope photograph, which shows an axially-cut cross-section of the catalyst according to Example No. 1, and which was focused on a cellular-wall surface observed between the cut cellular walls.

It is seen that the cellular-wall surfaces were provided with a large number of projections, which protruded into the cellular passages. Moreover, it is found that the projections had a height of 50 μm or more, and there existed such projections whose height was 200 μm approximately, In addition, it is understood that the projections grew from the pores of the cellular walls and were held firmly to the cellular walls by means of anchor effect. Note that, according to the result of an elemental analysis, it is believed that the projections comprised K mostly, and were specifically composed of potassium carbonate or potassium oxide.

### Comparative Example No. 1

A honeycomb substrate was prepared. Note that the honeycomb substrate was made from cordierite, and had a volume of 2 L. Moreover, the honeycomb substrate comprised cells in a quantity of 400 cells/in², and exhibited an average pore diameter of 3 μm and a porosity of 25% by volume. Also note that the prepared honeycomb substrate was for ordinary oxidizing catalysts or three-way catalysts, and did not comprise gas-permeable cellular walls at all.

A slurry was wash-coated on to the honeycomb substrate. Note that the major components of the slurry were alumina in an amount of 80 parts by weight, and zeolite in an amount of 70 parts by weight. The wash-coated honeycomb substrate was dried and calcined in the same manner as Example No. 1. Thus, a coating layer was formed on the honeycomb substrate. Note that the coating layer was formed in an amount of 150 g with respect to 1-L volume of the honeycomb substrate. Finally, using a platinum dinitrodiammine aqueous solution, Pt was loaded on the honeycomb substrate in an amount of 2 g with respect to 1-L volume of the honeycomb substrate.

### Comparative Example No. 2

Except that no potassium (K) was loaded on the honeycomb substrate, a catalyst according to Comparative Example No. 2 was prepared in the same manner as Example No. 1.

### Comparative Example No. 3

Except that the honeycomb substrate with Pt and K loaded on the alumina coating layer was not subjected to the heat treatment, a catalyst according to Comparative Example No. 3 was prepared in the same manner as Example No. 1.

### Example No. 2

A catalyst, which was prepared in the same manner as Comparative Example No. 1 except that the coating layer was formed in an amount of 200 g with respect to 1-L volume of the honeycomb substrate, was disposed on an exhaust-gas flow upstream side with respect to the catalyst according to Example No. 1. The combination of the resultant catalyst and catalyst according Example No. 1 was labeled a catalyst according to Example No. 2 of the present invention.

### Comparative Example No. 4

A catalyst, which was prepared in the same manner as Comparative Example No. 1 except that the coating layer was formed in an amount of 200 g with respect to 1-L volume of the honeycomb substrate, was disposed on an exhaust-gas flow upstream side with respect to the catalyst according to Example No. 1. The combination of the resultant catalyst and catalyst according Comparative Example No. 1 was labeled a catalyst according to Comparative Example No. 4.

### Test and Evaluation

The respective catalysts according to Example Nos. 1 and 2 as well as Comparative Example Nos. 1 through 4 were installed to an engine bench testing apparatus. Specifically, the catalysts were connected to an exhaust pipe of a 2-L displacement diesel engine, which the engine bench testing apparatus carried, respectively. Then, the diesel engine was run in the EC mode for 4 cycles. The catalysts were examined for the PMs reduction rate during each of the 4 cycles. The catalysts were evaluated in terms of their PMs reduction rates, which were averaged over 4 cycles. Table 1 below summarizes the evaluation results. Moreover, the maximum pressure losses, which the catalysts exhibited when diesel engine was run in the EC mode for 4 cycles, were measured. Table 1 summarizes the measured results as well. Note that the PMs reduction rates were found by calculating the proportions of the weight of PMs, which were emitted from the catalysts during each of the 4 cycles, with respect to the total weight of PMs emission from the diesel engine during each of the 4 cycles.

TABLE 1

| | | | PMs | Max. |
|---|---|---|---|---|
| | | Heat | Reduction | Pressure |
| | K | Treatment | Ratio (%) | Loss (kPa) |
| Ex. No. 1 | Comprised | Done | 22 | 2.3 |
| Comp. Ex. No. 1 | None | None | 5 | 1.6 |
| Comp. Ex. No. 2 | None | Done | 11 | 2.0 |
| Comp. Ex. No. 3 | Comprised | None | 12 | 2.1 |
| Ex. No. 2 | Comprised | Done | 28 | 3.9 |
| Comp. Ex. No. 4 | None | None | 8 | 3.2 |

From Table 1, it is understood that the catalyst according to Example No. 1 exhibited the higher PMs reduction rate than the catalysts according Comparative. Example Nos. 1 through 3 did. Likewise, the catalyst according to Example No. 2 exhibited the higher PMs reduction rate than the catalyst according Comparative Example No. 4 did. It is apparent that the catalysts according to Example Nos. 1 and 2 produced the advantage because they were provided with the projections. Note that the catalysts according to Example Nos. 1 and 2 showed the enlarged maximum pressure losses because they were provided with the projections. However, the maximum pressure losses, which were enlarged to such an extent, do not matter at all when putting the catalysts according to Example Nos. 1 and 2 to practical applications.

Moreover, the catalyst according to Example No. 2 exhibited a more upgraded average PMs reduction rate than the catalyst according Example No. 1 did. The difference between the average PMs reduction rate, which the catalyst according to Comparative Example No. 4 exhibited, and the average PMs reduction rate, the catalyst according to Comparative Example No. 1 exhibited, that is, 3%, is equivalent to the PMs reduction rate, which the additional oxidizing catalyst exhibited, additional oxidizing catalyst which was added to an exhaust-gas flow upstream side with respect to the catalyst according to Example No. 1 in the catalyst according to Example No. 2. However, the average PMs reduction rate, 28%, which the catalyst according to Example No. 2 exhibited, is greater than the simple sum of the average PMs reduction rate, 22%, which the catalyst according to Example No. 1 exhibited, and 3%. The fact implies that the catalyst according to Example No. 2 produced the advantage synergistically. Moreover, the catalyst according to Example No. 2 exhibited a remarkably greater average PMs reduction rate than the catalyst according Comparative Example No. 4 did. The advantage resulted from the fact that NO₂, which was generated at the additional oxidizing catalyst disposed on an exhaust-gas flow upstream side with respect to the simple catalyst according to Example No. 1, flowed into the simple catalyst according to Example No. 1 so that the resultant NO₂ facilitated the oxidation of PMs, which were captured onto the projections temporarily, even in and from a low-temperature region of about 250° C. or above.

### INDUSTRIAL APPLICABILITY

The present exhaust-gas purifying catalyst can be applied to the purification of exhaust gases emitted form internal combustion engines such as diesel engines, in particular to the purification of exhaust gases, which contain PMs.

1. A catalyst for purifying exhaust gases, the catalyst comprising:
a substrate provided with straight-flow gas-flow passages; and
projections protruding from the straight-flow gas-flow passages in a height of 50 μm or more, and comprising a precipitate composed of at least one catalytic ingredient selected from the group consisting of alkali metals and alkaline-earth metals.

2. The catalyst set forth in claim 1, wherein:
the straight-flow gas-flow passages are provided with a pore opening whose diameter is 10 μm or more; and
the projections are held onto the straight-flow gas-flow passages by means of anchor effect.

3. The catalyst set forth in claim 1 further comprising a catalytic layer formed on the straight-flow gas-flow passages and comprising a noble metal, wherein:
the projections protrude from the catalytic layer.

4. The catalyst set forth in claim 1 further comprising an oxidizing catalyst disposed on an exhaust-gas flow upstream side with respect to the catalyst.

5. The catalyst set forth in claim 1, wherein the substrate comprises a porous substrate.

6. The catalyst set forth in claim 5, wherein the porous substrate exhibits an average pore diameter of from 10 to 50 μm and a porosity of from 10 to 80% by volume.

7. The catalyst set forth in claim 1, wherein the projections protrude from the straight-flow gas-flow passages in a height of from 50 μm or more to 300 μm or less.

8. The catalyst set forth in claim 1, wherein the catalytic ingredient is loaded on the substrate in an amount of from 0.3 mol or more to 5 mol or less with respect to 1-L volume of the substrate.

9. The catalyst set forth in claim 3, wherein the catalytic ingredient is loaded in an amount of 4 mol or more with respect to 1-kg weight of the catalytic layer.

10. A process for producing a catalyst for purifying exhaust gases, the process comprising the steps of:
loading at least one catalytic ingredient, selected from the group consisting of alkali metals and alkaline-earth metals, on a substrate, provided with straight-flow gas-flow passages, in an amount of 0.3 mol or more with respect to 1-L volume of the substrate;
heat-treating the substrate with the catalytic ingredient loaded, thereby precipitating a precipitate, composed of the catalytic ingredient, so as to provide the straight-flow gas-flow passages with projections, protruding from the straight-flow gas-flow passages in a height of 50 μm or more.

11. The process set forth in claim 10, wherein the straight-flow gas-flow passages of the substrate are provide with a catalytic layer, which comprises a noble metal and which is formed in advance.

12. The process set forth in claim 10, wherein the substrate with the catalytic ingredient loaded is heat-treated at a temperature falling in a range of from 200 to 600° C.
